(19) United States
(12) Patent Application Publication
(10) Pub. No.: US 2011/0231333 A1
(43) Pub. Date: Sep. 22, 2011

(54) REGISTRATION METHOD AND REGISTRATION SYSTEM OF NETWORK SERVICE SYSTEM

(75) Inventor: Shugen CHEN, Shenzhen City (CN)

(73) Assignee: TENCENT TECHNOLOGY (SHENZHEN) COMPANY LIMITED, Shenzhen City (CN)

(21) Appl. No.: 13/117,234

(22) Filed: May 27, 2011

Related U.S. Application Data
(63) Continuation of application No. PCT/CN2009/073690, filed on Sep. 2, 2009.

(30) Foreign Application Priority Data
Dec. 3, 2008 (CN) 200810219639.3

(51) Int. Cl. G06Q 99/00

(52) U.S. Cl. 705/325

(57) ABSTRACT

A registration method includes dividing data items needed for registration into a first batch of data items needing to be verified and a second batch of data items not needing to be verified; receiving, by user side device, a first batch of content items corresponding to the first batch of data items, transmitting the first batch of content items to server side device before receiving a second batch of content items; invoking, by server side device, a verification standard, verifying the first batch of content items, identifying content items in the first batch with “verification-passed” if verification is passed, identifying content items in the first batch with “verification-failed” if verification isn't passed; after receiving the second batch of content items and if all content items in the first batch are identified with “verification-passed”, registering user, taking the first and second batches of content items as data of user, identifying user with “verification-passed”.

### FIELD OF THE INVENTION

The present invention relates to Internet communication technologies, and more particularly to a registration method and registration system of a network service system, and the network service system includes but not limited to a forum, a bulletin board system (BBS) and a Real-name community.

### BACKGROUND OF THE INVENTION

In a network service system, such as a Real-name forum, a true Social Network Service (SNS) community and part of BBSs, data of users need to be verified to ensure that the data is real. In order to urge the users to provide real data, a conventional network service system, such as a forum, a community and a BBS, usually limit authorities of to-be-verified users and verification-failed users. For example, the to-be-verified users and the verification-failed users only have a read authority but have no publication authority, or only have an authority of browsing captions but have no authority of browsing full texts, or only have an authority of browsing letters but have no authority of browsing pictures and downloading attachments and so on.

In the realization, the network service system usually establishes two user groups in advance, including a verification-passed user group and a to-be-verified or verification-failed user group, and configures authorities corresponding to the two user groups. For example, the verification-passed user group is authorized to read full texts, make responses and publication, and upload and download attachments; and the to-be-verified or verification-failed user group is only authorized to browse captions and attachment captions, and is not authorized to read full texts, make responses and publication, and upload and download attachments. When the network service system runs, a user is classified as one user group according to a verification result of the network service system, and is endowed with the authorities of the user group.

For example, the user needs to input and submit data when performing registration, and after the registration is completed, a server side device verifies the data of the user. In other words, the user is in a to-be-verified state when the registration is just completed, and only has the authorities of the to-be-verified or verification-failed user group. During a period of time after the registration of the user, a related person at the server side device verifies the data of the user; if the person determines, after the verification, that the data of the user is real, the user is identified as a user in a verified-passed state, and at this time, the user has the authorities of the verification-passed user group; if the person determines that the data of the user is unreal, the user is identified as a user in a verification-failed state, and still only has the authorities of the to-be-verified or verification-failed user group.

According to the conventional solutions, since the data of the user can not be verified unless the registration is completed, the time for processing the data of the user by the network service system is too long, so that the user can not obtain services provided by the network service system in time.

Therefore, it is required to provide a registration and verification system to shorten the time for processing the data of the user.

### SUMMARY OF THE INVENTION

A registration method which can verify data of a user in time is provided to solve the problem that the conventional registration method of the network service system can not verify the data of the user in time.

A registration method of a network service system is provided, which includes:

dividing data items needed for registration into a first batch of data items needing to be verified and a second batch of data items not needing to be verified;

receiving, by a user side device, a first batch of content items corresponding to the first batch of data items, and transmitting the first batch of content items to a server side device before receiving a second batch of content items corresponding to the second batch of data items;

invoking, by the server side device, a verification standard corresponding to the first batch of data items, verifying the first batch of content items based on the verification standard, identifying the content items in the first batch with “verification-passed” if the verification is passed, and identifying the content items in the first batch with “verification-failed” if the verification is not passed;

after the server side device receives the second batch of content items transmitted by the user side device, if all the content items in the first batch are identified with “verification-passed”, registering the user, taking the first batch of content items and the second batch of content items as data of the user, and identifying the user with “verification-passed”.

Compared with the conventional registration method of the network service system, the above registration method divides the data items needed for the registration into the first batch of data items needing to be verified and the second batch of data items not needing to be verified, and when the user inputs the content items corresponding to the second batch of data items, verifies the content items corresponding to the first batch of data items. In this way, for the user, the registration procedure and the verification procedure are performed at the same time, and the user becomes a verification-passed user once the registration is successful.

In an example of the present invention, the step of verifying the first batch of the content items includes:

after receiving the first batch of content items and before receiving the second batch of content items, estimating, by the server side device, a time point of submitting the second batch of content items by the user according to a time point of submitting the first batch of content items and a preset interval between submitting the first batch of content items and submitting the second batch of content items, and estimating a time point of completing the verification of the first batch of content items according to a current time point and a preset period of time needed for verifying the first batch of content items; if the time point of submitting the second batch of content items is later than the time point of completing the verification of the first batch of content items, verifying the first batch of content items inputted by the user.

The solution adopts a preferential-processing strategy, and preferentially processes users who can be verified in time, so as to ensure the number of verified users as much as possible.

In an example of the present invention, the registration method further includes:

after the server side device receives the second batch of content items, if the verification of the first batch of content items is completed and there are verification-failed content items, notifying the user of the verification-failed content items through the user side device and providing a modification entrance; if the content items modified by the user pass the verification, registering the user.

In the solution, the user can learn during the registration that which content items fail to pass the verification, so as to urge the user to modify the verification-failed content items and become a verification-passed user.

A registration system which can verify data of a user in time is provided to solve the problem that the conventional registration system of the network service system can not verify the data of the user in time.

A registration system of a network service system includes: a server side device and a user side device, wherein the server side device comprises a data item database, a user data database, a registration module and a verifying module, wherein

the data item database is configured to store data items needed for registration, the data items comprises a first batch of data items needing to be verified, a second batch of data items not needing to be verified, and a verification standard corresponding to the first batch of data items;

the user data database is configured to store data of a registered user, and the data of the user comprises a first batch of content items inputted by the user corresponding to the first batch of data items, and a second batch of content items inputted by the user corresponding to the second batch of data items;

the registration module is connected with the data item database, and is configured to read the first batch of data items and the second batch of data items from the data item database, transmit the first batch of data items and the second batch of data items to the user side device, and receive the first batch of content items and the second batch of content items inputted by the user from the user side device;

the verifying module is connected with the registration module, and is configured to receive the first batch of content items and the second batch of content items from the registration module; the verifying module is connected with the data item database to read the verification standard, and is configured to verify the first batch of content items based on the verification standard, identify content items passing the verification with “verification-passed”, and identify content items failing to pass the verification with “verification-failed”;

the registration module is further configured to, after receiving the second batch of content items from the user side device, determine according to verification results in the verifying module whether the content items in the first batch all pass the verification, if the content items in the first batch all pass the verification, register the user to the user data database, store the first batch of content items, the verification results corresponding to the first batch of content items and the second batch of content items in the user data database as the data of the user, and identify the user with “verification-passed”;

the user side device is configured to receive the first batch of content items corresponding to the first batch of data items, transmit the first batch of content items to the user data database before receiving the second batch of content items corresponding to the second batch of data items.

Compared with the conventional registration system of the network service system, the above registration system further includes a verifying module, the verifying module verifies, when the user inputs the second batch of content items not needing to be verified, the first batch of content items which is inputted by the user and needs to be verified. In this way, for the user, the registration procedure and the verification procedure are performed at the same time, and the user becomes a verification-passed user once the registration is successful.

### BRIEF DESCRIPTION OF THE DRAWINGS

FIG. 1 is a flowchart illustrating a registration method in accordance with an example of the present invention.

FIG. 2 is a flowchart illustrating a procedure of verifying content items inputted by a user in accordance with an example of the present invention.

FIG. 3 is a schematic diagram illustrating a registration system in accordance with an example of the present invention.

FIG. 4 is a schematic diagram illustrating a registration system in accordance with another example of the present invention.

### DETAILED DESCRIPTION OF THE INVENTION

A registration method provided by the examples of the present invention includes a procedure of verifying data of a user. The registration procedure and the verification procedure are performed at the same time, so as to shorten the time for processing the data of the user. For the user, the user can learn the state of the submitted data at the moment the user submits the data. A user passing the verification can immediately become a verification-passed user when performing the registration, and has normal authorities after the first logon, while a user failing to pass the verification will receive a prompt and can not enter the community unless the user affirms the prompt. In this way, the user can be urged to provide real data and thus user experience can be improved.

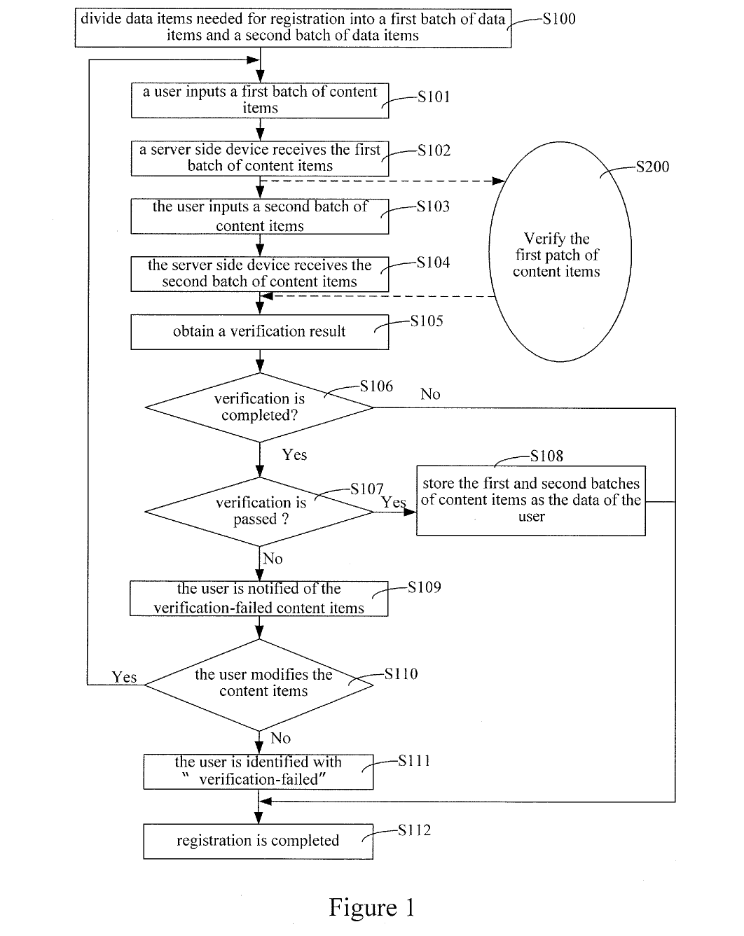

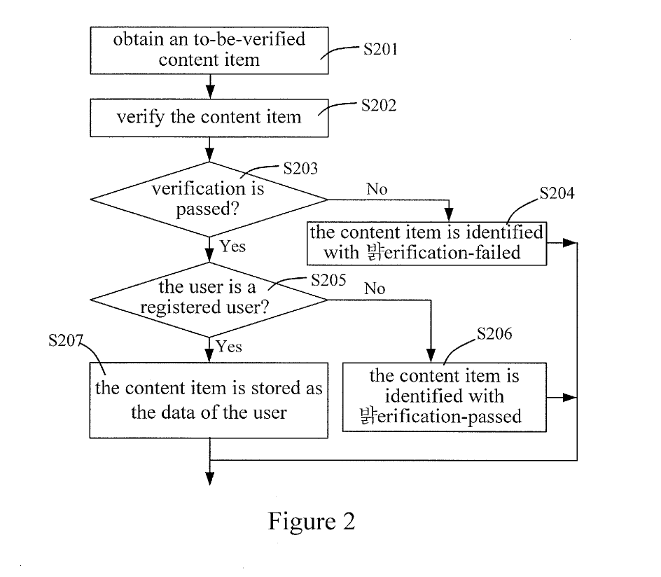

The registration method provided by the examples of the present invention is described hereinafter with reference to FIGS. 1 and 2. As shown in FIG. 1, in step S100, a server side device divides data items needed for the registration into a first batch of data items needing to be verified and a second batch of data items not needing to be verified; the first batch of data items may be but not limited to a user identity (ID), an email, a surname, a name, a birthday, an identification number, a head portrait picture, a school, a grade and so on. The second batch of data items may be but not limited to stature, a blood type, personal interests and so on.

In step S101, a user side device receives a first batch of content items which is inputted by a user and corresponds to the first batch of data items. Before the user inputs a second batch of content items corresponding to the second batch of data items, the server side device receives the first batch of content items, as shown in step S102.

On one hand, as shown in step S103, the user may continue to input the second batch of content items; on the other hand, as shown in step S200, the server side device invokes a verification standard corresponding to the first batch of data items to verify each content item in the first batch of content items, identifies content items passing the verification with “verification-passed”, and identifies content item failing to pass the verification with “verification-failed”, and detailed verification steps will be described with reference to FIG. 2. In other words, the verification steps shown in step S200 and the step of inputting the second batch of content items shown in step S103 are performed at the same time, and the step of inputting the second batch of content items by the user is independent from the verification steps. That is to say, the procedure of inputting the second batch of content items by the user is not affected by the verification procedure.

When the second batch of content items inputted by the user is transmitted to the server side device (step S104), the server side device obtains a verification result of the first batch of content items, as shown in step S105. Specifically, the server side device firstly determines whether the verification of the first batch of content items is completed (step S106); if the verification is completed, the server side device continues to determine whether the content items in the first batch all pass the verification (step S107), if content items in the first batch all pass the verification, the service side device will register the user, take the first batch of content items and the second batch of content items as the data of the user, and identify the user with “verification-passed”, as shown in steps S108 and S112.

In the above registration procedure, for the user, the registration procedure and the verification procedure are performed at the same time; after succeeding in the registration and becoming a verification-passed user, the user obtains normal authorities, which is helpful for the network service system to attract new users. Specifically, the first batch of data items is displayed firstly and then the second batch of data items is displayed, so as to lead the user to firstly input the first batch of content items and then input the second batch of content items. For example, the first batch of data items may be displayed on the first webpage, and after the user inputs the first batch of content items and clicks “submit”, the second batch of data items is displayed for the user.

In addition, as an improvement of the above registration method, in step S107, if the verification of the first batch of content items is completed and there are verification-failed content items, the user is notified of the verification-failed content items through the user side device (step S109), a modification entrance is provided and whether the user modifies the verification-failed content items is determined (step S110). If the user modifies the verification-failed content items, step S101 is returned to. Finally, if the content items modified by the user all pass the verification, the server side device registers the user, takes the first batch of content items and the second batch of content items as the data of the user, and the user is identified with “verification-passed”, as shown in steps S108 and S112. In other words, if not all the content items in the first batch inputted by the user pass the verification, by using the above registration method, the user is reminded in time, and is urged to modify the verification-failed content items in the first batch, thereby improving the proportion of the registration user passing the verification instantly.

Of course, if the user does not modify the verification-failed content items in step S110, the server side device still registers the user but identifies the user with “verification-failed” (referring to steps S111 and S112), so as to ensure that the user can succeed in the registration instantly. In this way, bad impression can be avoided for the user and thus the loss of potential and new users can be avoided. For the same reason, in step S104, when the server side device receives the second batch of content items submitted by the user, if the verification of the first batch of content items is not completed (referring to step S106), the server side device still registers the user (step S112), but identifies the user with “to-be-verified”, so as to ensure that the user can succeed in the registration instantly.

In other words, if the first batch of content items inputted by the user include verification-failed or to-be-verified content items, the user is still registered, the first batch of content items and the second batch of content items are taken as the data of the user, and the verification result of each piece of data is stored for being modified or perfected in the future. In other words, registered users are classified as verification-passed users, verification-failed users, and to-be-verified users according to the verification results. The registered users have authorities corresponding to the verification results. For example a verification-passed user can perform browsing, downloading and uploading, and a verification-failed and to-be-verified user can only perform browsing.

As an improvement of the above registration method, after the server side device receives the second batch of content items inputted by the user (step S104), if the verification of the first batch of content items is not completed and there are verification-failed content items, the server side device notifies the user of the verification-failed content items and the to-be-verified content items through the user side device; if the user modifies the verification-failed content items, the server side device continues to verify the to-be-verified content items, and verifies the modified content items after receiving the modified content items from the user; if the content items in the first batch all pass the verification in a preset period of time (such as one minute), the server side device registers the user, and takes the first batch of content items passing the verification and the second batch of content items as the data of the user; if the first batch of content items still includes verification-failed or to-be-verified content items in the preset period of time, the server side device still registers the user, and takes the first batch of content items and the second batch of content items as the data of the user. This improved registration method adopts a preferential-processing strategy, so as to ensure the number of registration users as much as possible in the case of limited verification resources.

As another improved solution, after step S102, i.e. after the server side device receives the first batch of content items submitted by the user and before the server side device receives the second batch of content items, the server side device can estimates a time point of submitting the second batch of content items by the user according to a time point of submitting the first batch of content items and a preset interval between submitting the first batch of content items and submitting the second batch of content items. Herein, the preset interval between submitting the first batch of content items and submitting the second batch of content items may be equal to but not limited to an experience value or a statistic value based on samples. The server side device may estimate a time point of completing the verification of the first batch of content items according to a current time point and a preset period of time needed for verifying the first batch of content items. Similarly, the preset period of time needed for verifying the first batch of content items may be equal to but not limited to an experience value or a statistic value based on samples. If the time point of submitting the second batch of content items is later than the time point of completing the verification of the first batch of content items, the first batch of content items inputted by the user are verified preferentially. In other words, this is a preferential-processing solution, if the current time point meets that the time point of submitting the first batch of content items plus the preset interval between submitting the first batch of content items and submitting the second batch of content items is larger than the current time point plus the preset period of time needed for verifying the first batch of content items, the current time point belongs to a golden processing period, which means that the verification of the first batch of content items can be completed before the user submits the second batch of content items; accordingly, the user should be processed preferentially, so as to ensure the number of verified users is as much as possible. The above preset interval and the preset period of time may be equal to a preset value, or an experience value, or an average obtained by using a statistic method. Obviously, the preferential-processing solution is applicable to the case of limited verification resources or the case that the verification of the first batch of content items is delayed at the server side device. Herein, the “delay” means that the server side device does not verify the first batch of content items immediately after receiving the first batch of content items, but starts to verify the first batch of content items after a certain period of time.

As an improved solution, when the user inputs the first batch of content items, it is determined through the user side device whether the user has inputted one of the content items in the first batch, which may be implemented based on the location change of a focus for inputting a letter by the user. If it is determined that the user has inputted one of the content items in the first batch, the content item is generally verified at the user side device; if the general verification is not passed, the user is prompted to modify the content item. In this solution, the user can be notified that which content items fail to pass the verification, so as to urge the user to modify the content items in time, and thus reduce the usage of verification resources at the server side device and improve the verification efficiency. The above general verification performed for the content item may include: verifying the type, the number or the format of characters, or verifying the size of a head portrait picture. For example, if a user ID can only include letters, numerals and underline, the user ID inputted by the user may be verified firstly to determine whether the above requirements are met. For another example, it may be determined whether an email inputted by the user is legal by determining whether the email inputted by the user includes “@” or whether a domain name following the “@” accords with the format of “*.*”. Those skilled in the art should understand that the general verification may be implemented through a script language, such as JavaScript.

In addition, if the content item passes the general verification, the user side device transmits the content item from the background to the server side device. For example, the content item inputted by the user may be transmitted to the server side device in time through such a technology as Ajac, without refreshing the webpage, so as to ensure the server side device can obtain the content item inputted by the user in time. In this way, the server side device has more time to verify the first batch of content items inputted by the user, thereby improving verification efficiency as much as possible.

FIG. 2 is a flowchart illustrating a procedure of verifying the content items inputted by the user in step S200 shown in FIG. 1. As shown in FIG. 2, the server side device obtains an to-be-verified content item in step S201, the content item is verified in step S202, and it is determined whether the content item passes the verification in step S203; if content item does not pass the verification, the content item is identified with “verification-failed” (step S204) and step S201 is returned to; if the content item passes the verification, the content item is identified with “verification-passed” (step S206). In addition, the registration method of the present invention may also be applied to the case of modifying personal data by a registered user; in this case, step S205 may be added to determine whether the user is a registered user, and if yes, the verification-passed content item is stored as the data of the user (step S207).

In an example of the present invention, the first batch of content items is verified by a machine, such as, it is verified whether the user ID is usable, whether the email is legal etc.; meanwhile, it may be verified whether the identification number of the user is correct, and whether the native place of the user matches a specific number field in the identification number. The machine may even perform time-consuming verification, e.g., automatically recognize and determine by using a machine image recognizing technology whether the head portrait picture submitted by the user meets the requirements.

In another example of the present invention, the verification may be performed by both a machine and a person. It can be seen from the above description about FIG. 1 that, as long as the verification of the first batch of content items is completed before the server side device completes the receipt of the second batch of content items submitted by the user, the purpose of real-time verification can be achieved. In addition, when the user is registered, the verification result of each content item inputted by the user is recorded, and the person timely verifies or reviews the verification-failed or to-be-verified content items.

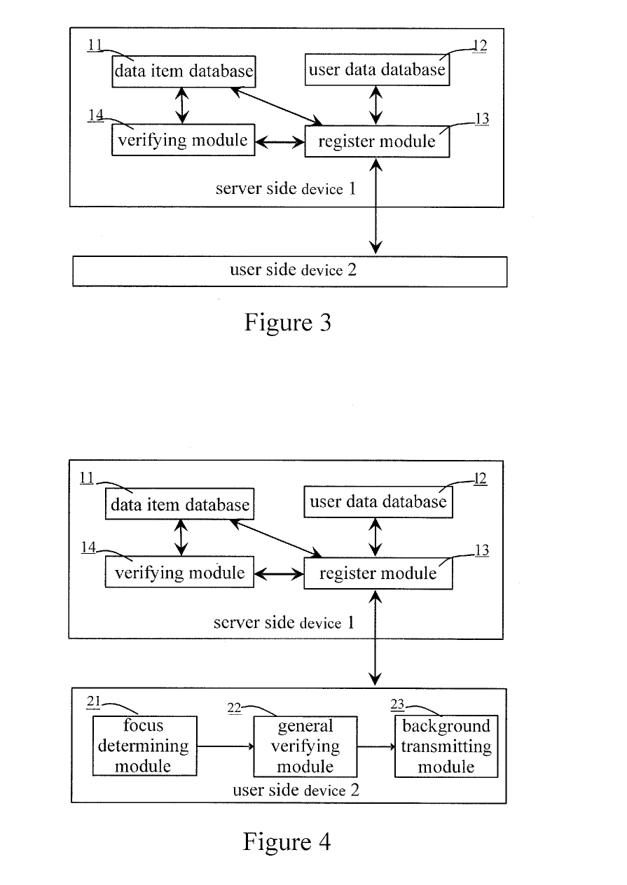

A registration system of a network service system provided by an example of the present invention is described with reference to FIG. 3. As shown in FIG. 3, the registration system includes a server side device 1 and a user side device 2. The server side device 1 includes a data item database 11, a user data database 12, a registration module 13 and a verifying module 14. The data item database 11 stores data items needed for the registration, the data items include a first batch of data items needing to be verified, a second batch of data items not needing to be verified, and a verification standard corresponding to the first batch of data items.

The user data database 12 is configured to store data of a registered user, and the data of the user include a first batch of content items inputted by the user corresponding to the first batch of data items, a second batch of content items corresponding to the second batch of data items, and a verification result of each content item.

The registration module 13 is connected with the data item database 11, reads the first batch of data items and the second batch of data items from the data item database 11, and transmits the first batch of data items and the second batch of data items to the user side device 2, so that the user can input the first batch of content items and the second batch of content items accordingly. The registration module 13 is also configured to receive from the user side device 2 the first batch of content items and the second batch of content items inputted by the user. In addition, the registration module 13 is connected with the verifying module 14, and the verifying module 14 receives the first batch of content items from the registration module 13 and verifies the first batch of content items; the verifying module 14 is also connected with the data item database 11 to read the verification standard, verifies the first batch of content items based on the verification standard, identifies content items passing the verification with “verification-passed”, and identifies content items failing to pass the verification with “verification-failed”.

As described above, in the registration procedure of the user, after receiving the second batch of content items from the user side device 2, the registration module 13 determines whether the content items in the first batch all pass the verification according to the verification results of the verifying module 14; if the content items in the first batch all pass the verification, registers the user to the user data database 12, stores the first batch of content items, the verification results corresponding to the first batch of content items and the second batch of content items in the user data database 12 as the data of the user, and identifies the user with “verification-passed”.

In addition, after receiving the second batch of content items from the user side device 2, if the verification of the first batch of content items is completed and there are verification-failed content items, the registration module 13 may notify the user of the verification-failed content items through the user side device 2 and provide a modification entrance; if the content items modified by the user pass the verification, the registration module 13 registers the user to the user data database 12, stores the first batch of content items, the verification results corresponding to the first batch of content items and the second batch of content items in the user data database 12 as the data of the user, and identifies the user with “verification-passed”.

As described above, in the registration procedure of the user, after receiving the second batch of content items from the user side device 2, if the verification of the first batch of content items is not completed, the registration module 13 may also register the user to the user data database 12, stores the first batch of content items, the verification results corresponding to the first batch of content items and the second batch of content items in the user data database 12 as the data of the user, and identifies the user with “to-be-verification”.

FIG. 4 shows an improvement of the registration system shown in FIG. 3. In the registration system shown in FIG. 4, the user side device 2 further includes a focus determining module 21, a general verifying module 22 and a background transmitting module 23. The focus determining module 21 determines based on the location change of a focus for inputting a letter by the user whether the user has inputted, one of the content items in the first batch corresponding to the first batch of data items; if yes, the general verifying module 22 is triggered; after being triggered, the general verifying module 22 generally verifies the content item, if the content item does not pass the general verification, prompts the user to modify the content item. The background transmitting module 23 is connected with the general verifying module 22, and transmits content items passing the verification performed by the general verifying module 22 to the registration module 13 in background. As described above, in a user side device of the browser type, the focus determining module 21, the general verifying module 22 and the background transmitting module 23 may be constructed by using a script language, such as JavaScript and Ajax.

The foregoing are only preferred examples of the present invention and are not for use in limiting the protection scope of the present invention. Any modification, equivalent replacement and improvement made within the scope of the present invention should be covered under the protection scope of the present invention.

1. A registration method of a network service system, comprising:
dividing data items needed for registration into a first batch of data items needing to be verified and a second batch of data items not needing to be verified;
receiving, by a user side device, a first batch of content items corresponding to the first batch of data items, and transmitting the first batch of content items to a server side device before receiving a second batch of content items corresponding to the second batch of data items;
invoking, by the server side device, a verification standard corresponding to the first batch of data items, verifying the first batch of content items based on the verification standard, identifying the content items in the first batch with “verification-passed” if the verification is passed, and identifying the content items in the first batch with “verification-failed” if the verification is not passed;
after the server side device receives the second batch of content items transmitted by the user side device, if all the content items in the first batch are identified with “verification-passed”, registering the user, taking the first batch of content items and the second batch of content items as data of the user, and identifying the user with “verification-passed”.

2. The registration method of claim 1, wherein verifying the first batch of the content items comprises:
after receiving the first batch of content items and before receiving the second batch of content items, estimating, by the server side device, a time point of submitting the second batch of content items by the user according to a time point of submitting the first batch of content items and a preset interval between submitting the first batch of content items and submitting the second batch of content items, and estimating a time point of completing the verification of the first batch of content items according to a current time point and a preset period of time needed for verifying the first batch of content items; if the time point of submitting the second batch of content items is later than the time point of completing the verification of the first batch of content items, verifying the first batch of content items inputted by the user.

3. The registration method of claim 1, further comprising:
after the server side device receives the second batch of content items, if the verification of the first batch of content items is completed and there are verification-failed content items, notifying the user of the verification-failed content items through the user side device and providing a modification entrance; if the content items modified by the user pass the verification, registering the user.

4. The registration method of claim 3, further comprising:
after the server side device receives the second batch of content items, if the verification of the first batch of content items is not completed and the user has been registered, taking the first batch of content items and the second batch of content items as the data of the user, and identifying the user with “to-be-verified”.

5. The registration method of claim 3, further comprising:
after the server side device receives the second batch of content items, if the verification of the first batch of content items is not completed and there are verification-failed content items, notifying the user of the verification-failed content items through the user side device; if the user modifies the verification-failed content items, continuing to verify to-be-verified content items, and verifying the modified content items after receiving the content items modified by the user;
if the first batch of content items passes the verification in a preset period of time, registering the user, and taking the first batch of content items passing the verification and the second batch of content items as the data of the user;
if the first batch of content items comprises verification-failed or to-be-verified content items in the preset period of time, registering the user, taking the first batch of content items and the second batch of content items as the data of the user; and identifying the user with “to-be-verified”.

6. The registration method of claim 1, further comprising:
when the user inputs the first batch of content items, determining based on location change of a focus for inputting a letter by the user, by the user side device, whether the user has inputted one of the content items in the first batch; if it is determined that the user has inputted one of the content items in the first batch, verifying, by the user side device, the format of the first batch of content items; if the format does not meet requirements, prompting the user to modify the first batch of content items.

7. The registration method of claim 6, wherein
verifying the format of the first batch of content items comprises: verifying at least one of the type, the number, or the format of characters, and the size of a head portrait picture.

8. The registration method of claim 7, further comprising:
transmitting the first batch of content items to the server side device if the format of the first batch of content items meets the requirements.

9. The registration method of claim 1, wherein
the first batch of data items comprises at least one of a user identity, an email, a surname, a name, an identification number, a birthday, gender, a head portrait picture, a school, and a grade.

10. The registration method of claim 9, further comprising:
recording verification results of the first batch of content items, wherein the verification results comprises a verification-passed result, a verification-failed result and a to-be-verified result;
verifying the to-be-verified content items of the user after registering the user.

11. A registration system of a network service system, comprising: a server side device and a user side device, wherein the server side device comprises a data item database, a user data database, a registration module and a verifying module, wherein
the data item database is configured to store data items needed for registration, the data items comprises a first batch of data items needing to be verified, a second batch of data items not needing to be verified, and a verification standard corresponding to the first batch of data items;
the user data database is configured to store data of a registered user, and the data of the user comprises a first batch of content items inputted by the user corresponding to the first batch of data items, and a second batch of content items inputted by the user corresponding to the second batch of data items;
the registration module is connected with the data item database, and is configured to read the first batch of data items and the second batch of data items from the data item database, transmit the first batch of data items and the second batch of data items to the user side device, and receive the first batch of content items and the second batch of content items inputted by the user from the user side device;
the verifying module is connected with the registration module, and is configured to receive the first batch of content items and the second batch of content items from the registration module; the verifying module is connected with the data item database to read the verification standard, and is configured to verify the first batch of content items based on the verification standard, identify content items passing the verification with “verification-passed”, and identify content items failing to pass the verification with “verification-failed”;
the registration module is further configured to, after receiving the second batch of content items from the user side device, determine according to verification results in the verifying module whether the content items in the first batch all pass the verification, if the content items in the first batch all pass the verification, register the user to the user data database, store the first batch of content items, the verification results corresponding to the first batch of content items and the second batch of content items in the user data database as the data of the user, and identify the user with “verification-passed”;
the user side device is configured to receive the first batch of content items corresponding to the first batch of data items, transmit the first batch of content items to the user data database before receiving the second batch of content items corresponding to the second batch of data items.

12. The registration system of claim 11, wherein
the registration module is configured to, after receiving the second batch of content items from the user side device and if the verification of the first batch of content items is completed and there are verification-failed content items, notify the user of the verification-failed content items through the user side device and provide a modification entrance; if the content items modified by the user pass the verification, the registration module is configured to register the user to the user data database, store the first batch of content items, verification results corresponding to the first batch of content items and the second batch of content items in the user data database as the data of the user, and identify the user with “verification-passed”.

13. The registration system of claim 12, wherein
the registration module is configured to, after receiving the second batch of content items from the user side device and if the verification of the first batch of content items is not completed, register the user to the user data database, store the first batch of content items, verification results corresponding to the first batch of content items and the second batch of content items in the user data database as the data of the user, and identify the user with “to-be-verified”.

14. The registration system of claim 11, wherein
the user side device further comprises a focus determining module and a general verifying module; wherein the focus determining module is configured to determine based on location change of a focus for inputting a letter by the user whether the user has inputted one of the content items in the first batch corresponding to the first batch of data item; if yes, trigger the general verifying module; the general verifying module is configured to, after being triggered, generally verify the format of the first batch of content items, if the general verification is not passed, prompt the user to modify the content items.

15. The registration system of claim 14, wherein
the user side device further comprises a background transmitting module, wherein the background transmitting module is connected with the general verifying module, and is configured to transmit content items passing the verification of the general verifying module in background to the registration module.
